(19) United States
(12) Patent Application Publication
(10) Pub. No.: US 2011/0291994 A1
(43) Pub. Date: Dec. 1, 2011

(54) TOUCH SCREEN PANEL AND DISPLAY DEVICE HAVING THE SAME

(75) Inventors: Won-Kyu Kwak, Yongin-City (KR); Jin-Woo Park, Yongin-City (KR)

(73) Assignee: Samsung Mobile Display Co., Ltd., Yongin-City (KR)

(21) Appl. No.: 12/980,615

(22) Filed: Dec. 29, 2010

(30) Foreign Application Priority Data
Jun. 1, 2010 (KR) 10-2010-0051677

(51) Int. Cl. G06F 3/042; G06F 3/041

(52) U.S. Cl. 345/176; 345/173

(57) ABSTRACT

A touch screen panel includes a plurality of first sensing patterns and a plurality of second sensing patterns formed in a touch active region and connected to each other in a first direction and in a second direction, respectively; and a plurality of position detecting lines positioned in a touch inactive region defined outside the touch active region and connected to each of the first sensing patterns and the second sensing patterns. At least one of the first sensing patterns and the second sensing patterns has a multilayered structure including at least one first electrode layer made of transparent conductive material and at least one second electrode layer made of non-transparent conductive material.

### CROSS-REFERENCE TO RELATED APPLICATION

This application claims the benefit of Korean Application No. 10-2010-0051677, filed Jun. 1, 2010, in the Korean Intellectual Property Office, the disclosure of which is incorporated herein by reference.

### BACKGROUND

1. Field

Aspects of the present invention relate to a touch screen panel and a display device having the same, and particularly to a touch screen having improved sensitivity with respect to a touch input and a display device having the same.

2. Description of the Related Art

A touch screen panel is an input device that enables a person to select a direction displayed on a screen with his/her finger or a tool and to input a user command.

To this end, the touch screen panel is provided at the front face of a display device to provide an electric signal based on a position at which a finger or a tool directly touches the touch screen panel. Then, a direction selected at the touched position is accepted as an input signal.

The touch screen panel can substitute for a separated input device such as a keyboard or a mouse, which are is connected to the display device. Accordingly, touch screens are becoming more popular.

There are several types of touch screen panels such as a resistive touch screen panel, an optical touch screen panel, and a capacitive touch screen panel.

The resistive touch screen panel and the capacitive touch screen panel include sensing patterns that sense changes of resistance and capacitance to detect a position of a touch input when a finger or an object such as a stylus pen touches the touch screen panel.

Since the sensing patterns are arranged on a display region where an image is displayed, the sensing patterns are generally formed to be transparent to secure transmittance of incident light from a display panel that is positioned at a lower side of the touch screen panel.

To this end, the sensing patterns are typically made of a transparent conductive material such as indium tin oxide (hereinafter, referred to “ITO”) or indium zinc oxide (hereinafter, referred to “IZO”).

However, since a transparent conductive material such as ITO or IZO has high surface resistance, sensitivity with respect to a touch input is inferior when the sensing patterns are made of the transparent conductive material.

### SUMMARY

Accordingly, aspects of the present invention provide a touch screen panel having sensitivity with respect to a touch input improved by reducing resistance of sensing patterns and a display device having the same.

In order to achieve the foregoing and/or other aspects of the present invention, there is provided a touch screen panel including: a plurality of first sensing patterns and a plurality of second sensing patterns formed in a touch active region wherein the plurality of first sensing patterns are connected to each other in a first direction and the plurality of second sensing patterns are connected to each other in a second direction; and a plurality of position detecting lines positioned in a touch inactive region located outside the touch active region, wherein each of the first sensing patterns and the second sensing patterns is connected to one of the plurality of position detecting lines; wherein at least one of the first sensing patterns and the second sensing patterns has a multilayered structure including at least one first electrode layer made of transparent conductive material and at least one second electrode layer made of non-transparent conductive material.

As a non-limiting aspect, a thickness of the second electrode layer may be less than that of the first electrode layer.

As a non-limiting aspect, the second electrode layer may be made of a material selected from the group consisting of silver (Ag), gold (Au), magnesium (Mg), copper (Cu), aluminum (Al), nickel (Ni), and alloys thereof.

As a non-limiting aspect, the second electrode layer may be made of silver (Ag) and thickness of the second electrode layer may be set within a range from 10 Å to 500 Å. For example, the thickness of the second electrode layer may be set within a range from 10 Å to 120 Å. Alternatively, the second electrode layer may be made of silver (Ag) and thickness of the second electrode layer may be set within a range from 200 Å to 500 Å.

As a non-limiting aspect, the first electrode layer may be made of a material selected from a group of indium titanium oxide (ITO) and indium zinc oxide (IZO).

As a non-limiting aspect, the multilayered structure may include the first electrode layer and the second electrode layer disposed under the first electrode layer.

As a non-limiting aspect, the multilayered structure may include the first electrode layer and the second electrode layer disposed on the first electrode layer.

As a non-limiting aspect, the multilayered structure may include two of the first electrode layers and the second electrode layer disposed between the two first electrode layers.

As a non-limiting aspect, the multilayered structure may include two of the second electrode layers and the first electrode layer disposed between the two second electrode layers.

As a non-limiting aspect, the multilayered structure may include at least twos of the first electrode layers and the second electrode layers which are alternately accumulated.

As a non-limiting aspect, all of the first sensing patterns and the second sensing patterns may have an multilayered structure including the first and second electrode layers.

As a non-limiting aspect, the first sensing patterns and the second sensing patterns may have the same multilayered structure.

As a non-limiting aspect, the first sensing patterns and the second sensing patterns may be alternately arranged in the touch active region to form a capacitive sensing cell such that the first sensing patterns positioned along the same row or along the same column are connected to each other by way of first connecting patterns arranged at the row or at the column in the first direction and that the second sensing patterns positioned at the same row or at the same column are connected to each other by way of second connecting patterns arranged along the row or along the column in the second direction crossing the first direction.

As a non-limiting aspect, a touch screen panel may include a plurality of spaced apart first sensing patterns that extend across the touch screen panel in a first direction and a plurality of spaced apart second sensing patterns that extend across the touch screen panel in a second direction that crosses the first direction and wherein the plurality of first sensing patterns and the plurality of second sensing patterns are spaced apart from each other in a third direction perpendicular to the first direction and the second direction to form a resistive touch electrode, and wherein at least one of the first sensing patterns and the second sensing patterns has an multilayered structure including at least one first electrode layer made of transparent conductive material and at least one second electrode layer made of non-transparent conductive material.

As a non-limiting aspect, at least ones of the first sensing patterns and the second sensing patterns may be formed on an upper substrate of a display panel positioned under the ones of the first and second sensing patterns and may be integrated with the display panel.

As a non-limiting aspect, a touch screen panel may include a plurality of sensing patterns that have a multilayered structure including at least one first electrode layer made of indium titanium oxide (ITO) or indium zinc oxide (IZO) and at least one second electrode layer made of silver (Ag), gold (Au), magnesium (Mg), copper (Cu), aluminum (Al), nickel (Ni), or alloys thereof, wherein a thickness of the second electrode layer is less than that of the first electrode layer.

In order to achieve the foregoing and/or other aspects of the present invention, there is provided a display device including: a display panel that displays an image; and a touch screen panel disposed on the display panel and including a plurality of first sensing patterns and a plurality of second sensing patterns; wherein at least some of the first sensing patterns and the second sensing patterns is formed on the upper substrate of the display panel so that the display panel is integrated with the touch screen panel, and at least ones of the first sensing patterns and the second sensing patterns have an multilayered structure including at least one first electrode layer made of a transparent conductive material and at least one second electrode layer made of a non-transparent conductive material.

According to aspects of the present invention, in order to implement a touch screen panel, the first and/or second sensing patterns connected to each other in different direction have an multilayered structure including a first electrode layer made of transparent conductive material and a second electrode layer having thickness restricted to secure a predetermined transmittance.

By providing the multilayered structure as described herein, reduction of transmittance of light supplied from a lower display panel is minimized and resistance of the sensing patterns is reduced to improve sensitivity against the touch input.

In addition, when the touch screen panel is integrated with the display panel by forming the first sensing patterns and/or the second sensing patterns of the touch screen panel on an upper substrate of the display panel, transmittance of light is improved and thickness of a touch screen panel built-in display device is reduced.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view illustrating a touch screen panel according to an embodiment of the present invention;

FIGS. 2A and 2B are enlarged views illustrating examples of the sensing patterns and connecting patterns of FIG. 1;

FIGS. 3A and 3B are enlarged section views illustrating portions of the touch screen panel taken along the lines of I-I′ of FIGS. 2A and II-II′ of FIG. 2B, respectively;

FIGS. 4A-4E are sectional views illustrating various examples related to the multilayered structure of the sensing patterns according to the embodiment of the present invention;

FIG. 5 is a plan view illustrating a touch screen panel according to another embodiment of the present invention;

FIG. 6 is a section view illustrating main parts of the touch screen panel of FIG. 5; and

FIGS. 7A and 7B are sectional views illustrating portions of a display device including the touch screen panel according to an embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain aspects of the present invention by referring to the figures. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, embodiments of the present invention will be described in detail with reference to the accompanying drawings.

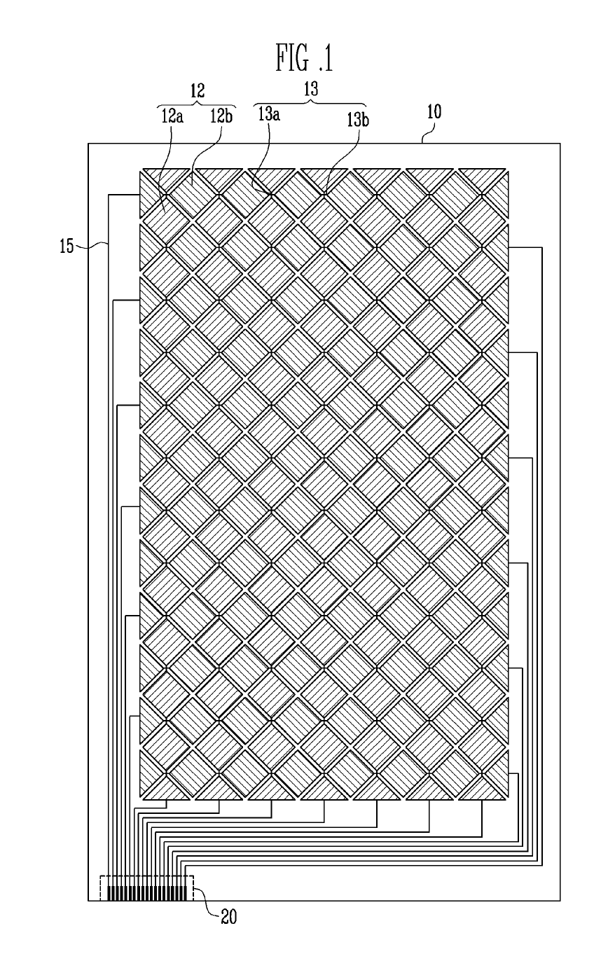

FIG. 1 is a plan view illustrating a touch screen panel according to an embodiment of the present invention.

Referring to FIG. 1 the touch screen panel includes a transparent substrate 10, sensing patterns 12 and connecting patterns 13 which are formed in a touch active region on the transparent substrate 10, and position detecting lines 15 formed in a touch inactive region outside the touch active region to connect the sensing patterns 12 to an external driving circuit through a pad unit 20.

The sensing patterns 12 include a plurality of first sensing patterns 12a formed in the touch active region and connected to each other along the first direction and a plurality of second sensing patterns 12b formed in the touch active region to be connected to each other along the second direction crossing (for example, perpendicular to) the first direction.

FIG. 1 illustrates an example of a capacitive touch screen panel in which the first sensing patterns 12a and the second sensing patterns 12b are provided by capacitive sensing cells alternately scattered and arranged in the touch active region in a non-overlapping arrangement.

That is, the first sensing patterns 12a are arranged in rows and/or in columns such that the first sensing patterns 12a positioned in the same rows or in the same columns (in the same columns in this embodiment) are connected to each other in the first direction (in the column direction in this embodiment) by first connecting patterns 13a that are arranged in the same columns. In this embodiment, each first sensing pattern 12a in a given column is connected to a respective position detecting line 15 through the first connecting patterns 13a.

The second sensing patterns 12b are arranged in rows and/or in columns such that the second sensing patterns 12b positioned in the same rows or in the same columns (in the same rows in this embodiment) are connected to each other in the second direction (in the row direction in this embodiment) crossing the first direction by second connecting patterns 13b that are arranged in the same rows. In this embodiment, each second sensing pattern 12b in a given row is connected to a respective position detecting line 15 through the first connecting patterns 13a.

It is to be understood that the term “row” and the term “column” may be used interchangeably and may differ according to the orientation of a touch screen panel. In FIG. 1, the term “column” is used to designate first sensing patterns 12a, which are connected to each other through the first connecting patterns 13a in a direction down the page (herein, also referred to as the “first direction” and the term “row” is used to designate second sensing patterns 12b, which are connected to each other in a direction across the page (herein, also referred to as the “second direction”.

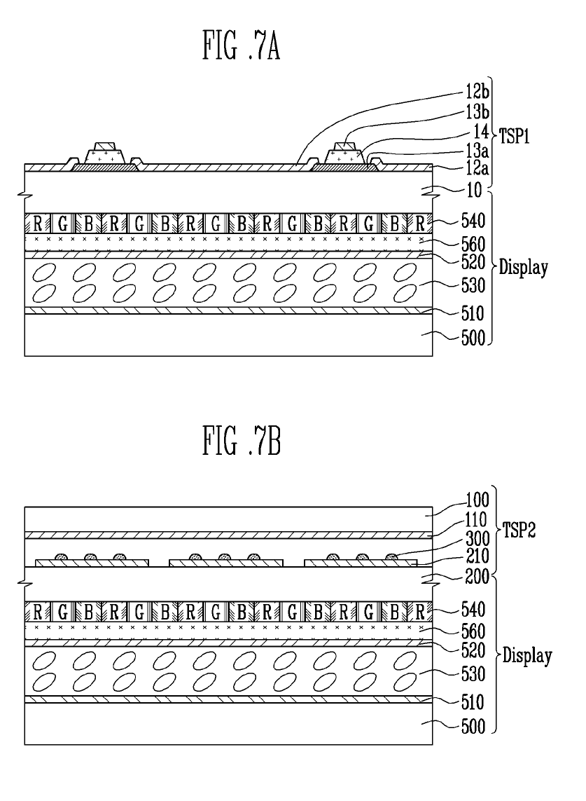

The first sensing patterns 12a and the second sensing patterns 12b are transparent in order to have a transmittance higher than a preset transmittance such that light from a display panel (see, for example, FIGS. 7A and 7B) disposed at the lower side is transmitted through the touch screen panel. For example, the first and second sensing patterns 12a and 12b include a transparent electrode layer made of a transparent material such as ITO.

The connecting patterns 13 include a plurality of first connecting patterns 13a formed in the first direction and connecting the first sensing patterns 12a to each other in the first direction and a plurality of second connecting patterns 13b formed in the second direction and connecting the second sensing patterns 12b to each other in the second direction.

The position detecting lines 15 are electrically connected to the respective rows and columns of the first and second sensing patterns connected to each other in the first and second direction and connect the first and second sensing patterns 12a and 12b to an external driving circuit (not shown) such as a position detecting circuit through the pad unit 20.

The position detecting lines 15 are not positioned in the touch active region where an image is displayed but in a touch inactive region provided outside the touch active region. The position detecting lines 15 may be made of various materials, such as, for example, a transparent conductive material used in forming the sensing patterns 12 and low resistance material such as molybdenum (Mo) silver (Ag), titanium (Ti), copper (Cu), aluminum (Al), or molybdenum/aluminum/molybdenum (Mo/Al/Mo).

The touch screen panel of the present embodiment is a capacitive touch screen panel wherein, when a touching object such as a finger or a stylus pen is touches the touch screen panel 10, a change of capacitance at the touch position is transmitted from the touched sensing patterns 12 to the driving circuit (not shown) via the position detecting lines 15 and the pad unit 20. Then, the change of capacitance is converted into an electric signal by X- and Y-input processing circuits (not shown) and the touch position is recognized.

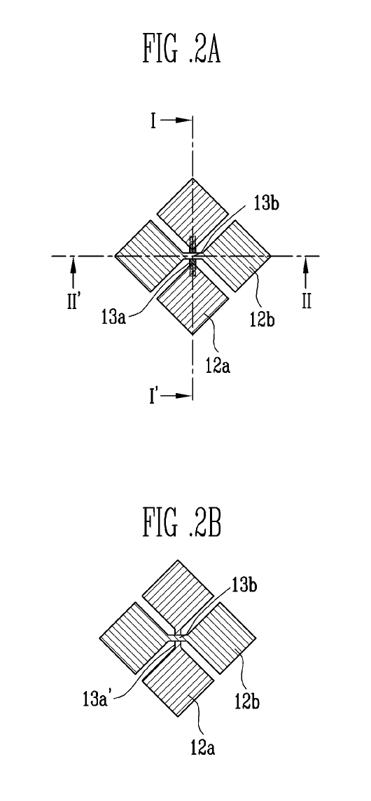

FIGS. 2A and 2B are enlarged views illustrating parts of the sensing patterns and the connecting patterns of FIG. 1. FIG. 2A shows an example of a touch screen panel having a one-level structure in which the first sensing patterns 12a and the second sensing patterns 12b are arranged on the same level. FIG. 2B shows an example of a touch screen panel having a two-level structure in which the first sensing patterns 12a and the second sensing patterns 12b are arranged in different levels.

Firstly, referring to FIG. 2A, the first and second sensing patterns 12a and 12b are alternately arranged on the same level and connected to each other in the first direction and in the second direction by the first connecting patterns 13a and the second connecting patterns 13b, respectively.

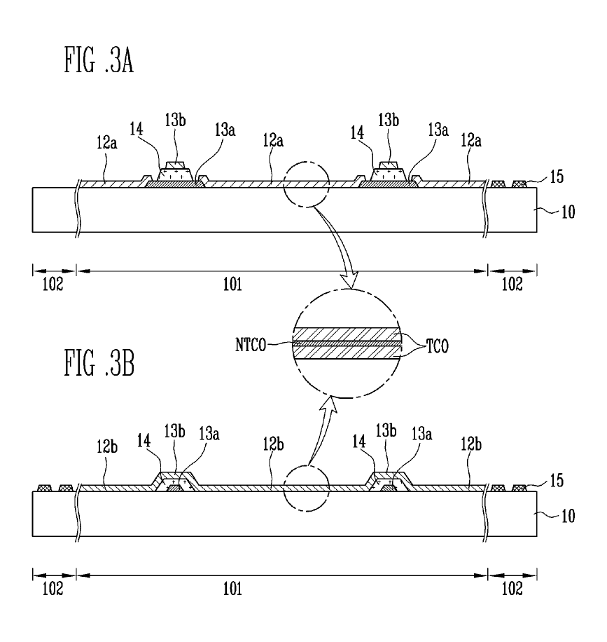

In order to provide insulation between the first connecting patterns 13a and the second connecting patterns 13b, an insulating layer 14 (see FIGS. 3A and 3B) is interposed between the first and second connecting patterns 13a and 13b interpose an the first connecting patterns 13a and the second connecting patterns 13b are positioned on different levels.

For example, the first connecting patterns 13a may be positioned above or below the level where the first and second sensing patterns 12a and 12b are positioned and are connected to the first sensing patterns 12a through contact holes or by a direct contact. The second connecting patterns 13b are positioned on the same level as the level where the first and second sensing patterns 12a and 12b are positioned and may be integrally patterned with the second sensing patterns 12b.

In this case, the first sensing patterns 12a may be separated and patterned to have independent patterns and may be connected to each other in the first direction by the first connecting patterns 13a that are positioned on a level different from that of the first sensing patterns 12a.

Alternatively, the first and second sensing patterns 12a and 12b may be positioned not on the same level but in different, alternately arranged, levels respectively.

In this case, as illustrated in FIG. 2B, the first connecting patterns 13a may be positioned on the same level as that where the first sensing patterns 12a are positioned and may be integrally patterned with the first sensing patterns 12a, and the second connecting patterns 13b may be positioned on the same level where the second sensing patterns 12b may be positioned and may be integrally patterned with the second sensing patterns 12b.

In this case, an insulating layer may be disposed on the entire touch active region between the level where the first sensing patterns 12a and the first connecting patterns 13a are formed and the level where the second sensing patterns 12b and the second connecting patterns 13b are formed.

FIGS. 2A and 2B show examples in which the first and second connecting patterns 13a and 13b cross each other, but the present invention is not limited thereto. For example, the first connecting patterns 13a may connect the first sensing patterns 12a to each other in the first direction by taking a detour to a path overlapping the second connecting patterns 13b without crossing the second connecting patterns 13b. In this case, an insulating layer may be disposed between the first connecting patterns 13a and the second sensing patterns 12b to provide insulation.

FIGS. 3A and 3B are enlarged section views illustrating portions of the touch screen panel taken along the lines of I-I′ and II-II′ of FIG. 2A. FIG. 3A shows a sectional view of main portions of the touch screen panel taken along the line I-I′ of FIG. 2A and FIG. 3B shows a sectional view of the touch screen panel taken along the line II-II′ of FIG. 2A.

Referring to FIGS. 3A and 3B, the first and second sensing patterns 12a and 12b and the first and second connecting patterns 13a and 13b are formed in the touch active region 101, and insulating layers 14 are disposed between the first and second connecting patterns 13a and 13b to provide insulation. The position detecting lines 15 made of a low resistance material are formed in the touch inactive region 102 outside of the touch active region 101.

The insulating layers 14 are formed such that portions of the first connecting patterns 13a, for example, both ends of the first connecting patterns 13a connected to the first sensing patterns 12a, are exposed. When both ends of the exposed first connecting patterns 13a are connected to the first sensing patterns 12a, the first sensing patterns 12a are connected to each other in the first direction, for example, the column direction according to FIG. 1.

The second connecting patterns 13b are patterned to be integrated with the second sensing patterns 12b in the second direction, for example, the row direction according to FIG. 1, by passing over the upper portions of the insulating layers 14. By doing so, the second sensing patterns 12b are connected to each other in the second direction.

FIGS. 3A and 3B show examples of the sections of the sensing patterns and the connecting patterns that are provided in the touch screen panel having the one-level structure as illustrated in FIG. 2A, wherein, for the purpose of description examples, the insulating layers 14 are disposed at the crossed portions between the first connecting patterns 13a and the second connecting patterns 13b. However, the present invention is not limited thereto. For example, the insulating layers may be formed on the entire touch active region and the sensing patterns (for example, the first sensing patterns 12a) may be positioned on the different levels and the connecting patterns (for example, the first connecting patterns 13a) to connect the sensing patterns may be electrically connected to each other through contact holes formed in the insulating layers.

Although FIGS. 3A and 3B show examples in which the first connecting patterns 13a are positioned under the insulating layers 14 and the second connecting patterns 13b are positioned above the insulating layers 14, the positions of the first connecting patterns 13a and the second connecting patterns 13b may be reversed.

The touch active region 101 is transparent such that light from the display panel under the touch screen panel transmits therethrough. That is, the first and second sensing patterns 12a and 12b and the second connecting patterns 13b, and the insulating layers 14 are made of a transparent material having transmittance equal to or higher than a preset transmittance. Here, the term transparency generally refers to a property of being completely transparent or having high transmittance.

To this end, the first and second sensing patterns 12a and 12b and the second connecting patterns 13b may include a transparent conductive material such as ITO or IZO, and the insulating layers 14 may be made of a transparent insulating material such as silicon oxide (SiO₂).

The first connecting patterns 13a may be made of a transparent material like that of the first and second sensing patterns 12a and 12b and the second connecting patterns 13b or of an opaque low resistance metal like that of the position detecting lines 15, wherein line width, length, and thickness thereof may be controlled to prevent the connection patterns 13a from being seen.

However, since a transparent conductive material such as ITO and IZO has high surface resistance, sensitivity with respect to a touch input may be inferior when the first and second sensing patterns 12a and 12b are made of a transparent conductive material.

Therefore, aspects of the present invention are characterized in that at least one of the first and second sensing patterns 12a and 12b includes a multilayered structure having at least one first electrode layer made of a transparent conductive material (TCO) such as ITO and IZO and at least one second electrode layer made of a non-transparent conductive material (NTCO) such as silver (Ag) so that sensitivity with respect to a touch input is improved.

For example, the first and second sensing patterns 12a and 12b may have a multilayered structure including two first electrode layers made of TCO and a second electrode layer disposed between the two first electrode layers and made of NTCO.

In this case, the first and second sensing patterns 12a and 12b may have the same multilayered structure for ease of manufacture. However, the present invention is not limited thereto, and the first and second sensing patterns 12a and 12b may have different structures.

For example, the first sensing patterns 12a connected to each other in the longer side direction of a screen and sensitive to resistance may have a multilayered structure including at least one first electrode layer and at least one second electrode layer, and the second sensing patterns 12b may have a single layer structure including a single first electrode layer.

In addition, all of the first and second sensing patterns 12a and 12b may have the multilayered structure including at least one first electrode layer and at least one second electrode layer and the multilayered structure and material of the sensing patterns may be different from each other.

The thickness of the second electrode layer that is made of the low resistance NTCO may be limited within a preset range to allow transmittance.

For example, when the second electrode layer is made of silver (Ag), the thickness of the second electrode layer may be set to be 500 Å or less, such as, for example, in a range of 10 Å to 500 Å.

Particularly, when resistance of the sensing patterns 12a and 12b is lowered and high transmittance must be maintained, one second electrode layer may be provided and the thickness thereof may be less than 120 Å.

For example, the first sensing patterns 12a and/or the second sensing patterns 12b (or including the second connecting patterns 13b integrally formed with and made of the same material as that of the second sensing patterns 12b) may have a three layer multilayered structure in which the first electrode layer, the second electrode layer, and the first electrode layer are sequentially layered, the first sensing patterns 12a and/or the second sensing patterns 12b may have a multilayered structure of ITO (300 Å), Ag (10 to 120 Å), and ITO (300 Å). In this case, light transmittance through the first sensing patterns 12a and/or the second sensing patterns 12b may be secured to be higher than 90% and surface resistance may be lower than 10 Ω.

In addition, when transmittance is slightly lowered and low surface resistance is secured, the first sensing patterns 12a and/or the second sensing patterns 12b may have a layered structure of ITO (300 Å), Ag (200 to 500 Å), and ITO (300 Å). In this case, the touch screen panel may be radiolucent and may serve as a mirror.

That is, the thickness of the second electrode layer may be restricted such that the thickness of the second electrode layer made of NTCO is controlled according to characteristics and uses desired for the touch screen panel and light from the lower display panel may transmit higher than a predetermined transmittance (for example, higher than 50% including radiolucent type).

That is, in order to secure transmittance, the thickness of the second electrode layer may be restricted. For example, the thickness of the second electrode layer may be less than that of the first electrode layer.

According to aspects of the present invention as described above, the first sensing patterns 12a and/or the second sensing patterns 12b connected to each other in different directions to form the touch screen panel have a multilayered structure including a first electrode layer made of TCO and a second electrode layer made of NTCO and having restricted thickness to secure a predetermined transmittance.

By forming such a structure as describe above, reduction of transmittance of light supplied from the lower display panel may be minimized and resistance of the sensing patterns 12a and 12b may be reduced so that sensitivity with respect to the touch input, precision, and an output cycle may be improved.

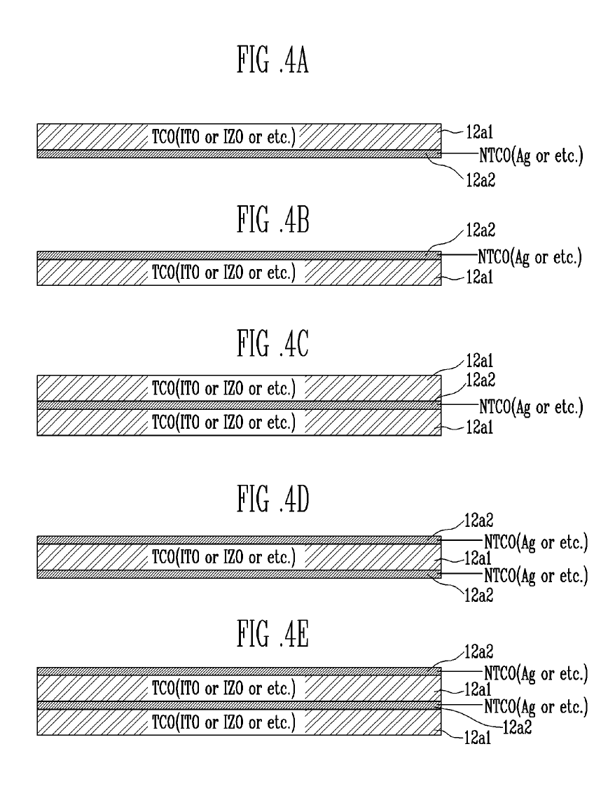

FIGS. 4A-4E are sectional views illustrating various examples related to multilayered structures of the sensing patterns according to embodiments of the present invention.

Referring to FIGS. 4A-4E, the multilayered structure of sensing patterns, that is, the multilayered structure of the first and/or second sensing patterns includes at least one first electrode layer 12a1 made of TCO and at least one second electrode layer 12a2 made of NTCO.

For example, the multilayered structure of the sensing patterns may includes a single first electrode layer 12a1 and a single second electrode layer 12a2, wherein the second electrode layer 12a2 and the first electrode layer 12a1 are sequentially layered from the lower side as illustrated in FIG. 4A or the first electrode layer 12a1 and the second electrode layer 12a2 are sequentially layered from the lower side as illustrated in FIG. 4B.

That is, the multilayered structure of the sensing patterns may include an embodiment in which the second electrode layer 12a2 is disposed lower than the first electrode layer 12a1 or in which the second electrode layer 12a2 is disposed upon the first electrode layer 12a1.

In addition, the multilayered structure of the sensing patterns may further include at least one additional first electrode layer 12a1 and/or at least one additional second electrode layer 12a2.

For example, the multilayered structure of the sensing patterns may include two first electrode layers 12a1 and a single second electrode layer 12a2 disposed between the two first electrode layers 12a1 as illustrated in FIG. 4C, or two second electrode layers 12a2 and a single first electrode layer 12a1 disposed between the two second electrode layers 12a2 as illustrated in FIG. 4D.

In addition, the sensing patterns may further include at least one additional first electrode layer 12a1 and at least one additional second electrode layer 12a2. That is, the multilayered structure of the sensing patterns may include at least two first electrode layers 12a1 and at least two second electrode layers 12a2, which may have a structure that the first electrode layers 12a1 and the second electrode layer 12a2 are alternately layered as illustrated in FIG. 4E.

FIG. 4E shows an multilayered structure in which the first electrode layer 12a1, the second electrode layer 12a2, the first electrode layer 12a1, and the second electrode layer 12a2 are sequentially layered starting with a first electrode layer 12a1 as the lowest layer, but the positions of the first electrodes 12a1 and the second electrode layers 12a2 may be reversed.

The first electrode layer 12a1 may be made of a material selected from the group of ITO, IZO, ITZO, and TCO and the second electrode layer 12a2 may be made of a low resistance NTCO selected from the group of silver (Ag), gold (Au), magnesium (Mg), copper (Cu), aluminum (Al), nickel (Ni), and alloys thereof.

The second electrode layer 12a2 may be made of an NTCO having a restricted thickness such that a predetermined transmittance is secured. For example the second electrode layer 12a2 may have a thickness less than that of the first electrode layer 12a1. For example, when the second electrode layer 12a2 is made of silver (Ag), the thickness of the respective second electrode layers 12a2, as described above with reference to FIGS. 3A and 3B, is set within a range from 10 Å to 120 Å in order to secure high transmittance, or within a range from 200 Å to 500 Å in order to reduce surface resistance and to implement radiolucent touch screen panel.

In addition to the structures of FIGS. 4A-4E, the multilayered structure of the sensing patterns may be formed to include at least one first electrode layer 12a1 and at least one second electrode layer 12a2 such that resistance of the sensing patterns may be reduced within a range of a satisfying predetermined transmittance of light supplied from the lower display panel and sensitivity with respect to the touch input may be improved.

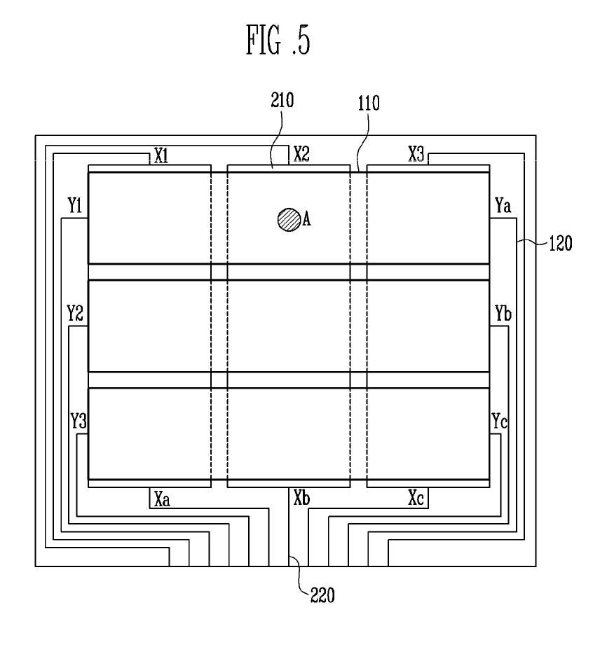

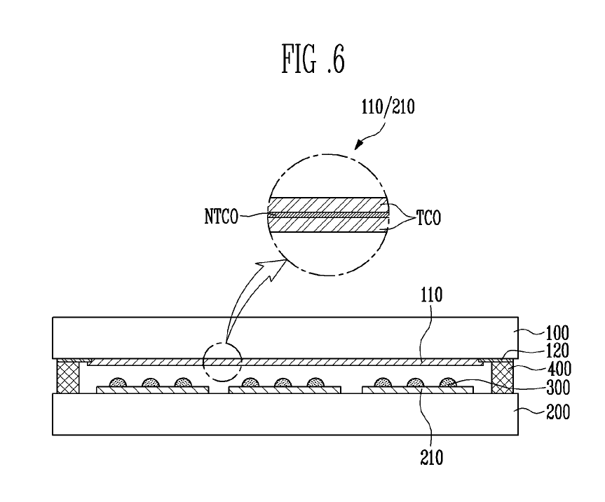

FIG. 5 is a plan view illustrating a touch screen panel according to another embodiment of the present invention, and FIG. 6 is a section view illustrating portions of the touch screen panel of FIG. 5.

Referring to FIGS. 5 and 6, the touch screen panel includes a plurality of first sensing patterns 110 and a plurality of second sensing patterns 210 formed on the touch active region and connected to each other in the first direction and in the second direction respectively, and a plurality of position detecting lines 120 and 220 positioned in a touch inactive region defined outside the touch active region and connected to the first sensing patterns 110 and the second sensing patterns 210 respectively.

Particularly, FIGS. 5 and 6 show an example of a resistive touch screen panel in which the first and second sensing patterns 110 and 210 are provided as resistive touch electrodes which are separated in the longitudinal direction and in the transversal direction by a predetermined distance and extend in the first direction (for example, in the row direction) and in the second direction crossing the first direction (for example, in the column direction).

In more detail, the touch screen panel according to this embodiment includes an upper substrate 100 in which the first sensing patterns 110 extending in the first direction and the first position detecting lines 120 connected to the first sensing patterns 110 are formed, a lower substrate 200 in which the second sensing patterns 210 extending in the second direction and the second position detecting lines 220 connected to the sensing patterns 210 are formed, a plurality of dot spacers 300 positioned between the first sensing patterns 110 and the second sensing patterns 210 and providing a conducting connection between the first sensing patterns 110 and the second sensing patterns 210 at a touch position when a touch input is provided, and an adhesive 400 bonding the upper substrate 100 with the lower substrate 200.

In this embodiment, the first and second sensing patterns 110 and 210 overlap each other and are separated by a distance, and an insulated state is maintained therebetween when a touch input is not provided. When a touch position is pressed by a touch input, the first sensing pattern 110 is conductively connected to the second sensing pattern 210 at the touch position through the dot spacer 300. At this time, whether a touch occurs and the position of the touch are recognized through a voltage sensed through the first position detecting line 120 connected to the first sensing pattern 110 and the second position detecting line 220 connected to the second sensing pattern 210.

Even in this embodiment, at least one of the first and second sensing patterns 110 and 210 has a multilayered structure including at least one first electrode layer made of TCO and at least one second electrode layer made of NTCO.

Since the embodiment of the multilayered structure has been described in various ways in the multilayered structure of the first and second sensing patterns 12a and 12b provided in the capacitive touch screen panel in the previous embodiments, its description will be not be repeated here.

Therefore, even in this embodiment, for the implementation of the touch screen panel, the first sensing patterns 110 and/or the second sensing patterns 210 connected to each other in different directions have a multilayered structure including a first electrode layer made of TCO and a second electrode layer made of NTCO and having thickness restricted to provide a predetermined transmittance so that sensitivity with respect to the touch input can be improved.

Meanwhile, the touch screen panel according to aspects of the present invention described with reference to FIGS. 1 to 6 may be formed on an independent substrate and attached to an upper side of a display device or integrally formed with a display panel of the display device.

That is, the display device according to an embodiment of the present invention may include a display panel DISPLAY that displays an image and a touch screen panel TSP having a plurality of first sensing patterns 12a or 110 and a plurality of second sensing patterns 12b or 210 disposed on the display panel to receive a touch input, wherein the touch screen panel TSP may be integrally formed with the display panel DISPLAY by forming the first sensing patterns 12a or 110 and/or the second sensing patterns 12b or 210 of the touch screen panel TSP on the upper substrate of the display panel DISPLAY.

To this end, as illustrated in FIG. 7A, the first and second sensing patterns 12a and 12b and the first and second connecting patterns 13a and 13b, which are provided in the capacitive touch screen panel TSP1 having the one-level structure, may be integrally formed on the upper substrate 10 of the display panel DISPLAY. In addition, although not illustrated in FIG. 7, in the two-level capacitive touch screen panel, the first or second sensing patterns 12a or 12b may be integrally formed on the upper substrate 10 of the display panel DISPLAY.

As illustrated in FIG. 7B, some of the sensing patterns provided in the resistive touch screen panel TSP2, such as, for example, the second sensing patterns 210 provided on the lower substrate of the resistive touch screen panel are formed on the upper substrate 200 of the display panel DISPLAY so that the lower substrate of the touch screen panel can be integrally formed with the upper substrate 200 of the display panel.

That is, the touch screen panel TSP is integrated with the display panel DISPLAY by forming the first sensing patterns 12a or 110 and/or the second sensing patterns 12b or 210 of the touch screen panel on the upper substrate of the display panel so that an air gap between the touch screen panel TSP and the display panel DISPLAY can be removed, transmittance of light is improved, and thickness of a touch screen panel built-in display device can be reduced.

Meanwhile, although FIGS. 7A and 7B illustrate the display panel DISPLAY provided under the touch screen panel TSP as a liquid crystal display panel for the purpose of description, this is only an example. The display panel DISPLAY may be implemented by various display panels that display an image, such as an organic light emitting display panel, in addition to the liquid crystal display panel.

In FIGS. 7A and 7B, reference numeral 500 indicates a lower substrate of the liquid crystal display panel, 510 and 520 indicate a pixel electrode and a common electrode respectively, 530 indicates a liquid crystal layer, 540 indicates a color filter, and 560 indicates an overcoating layer.

Since the structure of the liquid crystal display panel is well known, FIGS. 7A and 7B show the liquid crystal display panel simply and a description will be omitted.

As described above, when the touch screen panel TSP is integrated with the display panel DISPLAY, transmittance of light may be improved and thickness of the touch screen panel built-in display device may be reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A touch screen panel comprising:
a plurality of first sensing patterns and a plurality of second sensing patterns formed in a touch active region, wherein the plurality of first sensing patterns are connected to each other in a first direction and the plurality of second sensing patterns are connected to each other in a second direction; and
a plurality of position detecting lines positioned in a touch inactive region located outside the touch active region, wherein each of the first sensing patterns and the second sensing patterns is connected to one of the plurality of position detecting lines;
wherein at least one of the first sensing patterns and the second sensing patterns has a multilayered structure including at least one first electrode layer made of transparent conductive material and at least one second electrode layer made of non-transparent conductive material.

2. The touch screen panel as claimed in claim 1, wherein a thickness of the second electrode layer is less than that of the first electrode layer.

3. The touch screen panel as claimed in claim 1, wherein the second electrode layer is made of a material selected from the group consisting of silver (Ag), gold (Au), magnesium (Mg), copper (Cu), aluminum (Al), nickel (Ni), and alloys thereof.

4. The touch screen panel as claimed in claim 1, wherein the second electrode layer is made of silver (Ag) and wherein the thickness of the second electrode layer is within a range from 10 Å to 500 Å.

5. The touch screen panel as claimed in claim 1, wherein the second electrode layer is made of silver (Ag) and wherein the thickness of the second electrode layer is within a range from 10 Å to 120 Å.

6. The touch screen panel as claimed in claim 1, wherein the second electrode layer is made of silver (Ag) and the thickness of the second electrode layer is within a range from 200 Å to 500 Å.

7. The touch screen panel as claimed in claim 1, wherein the first electrode layer is made of a material selected from the group consisting of indium titanium oxide (ITO) and indium zinc oxide (IZO).

8. The touch screen panel as claimed in claim 1, wherein the multilayered structure includes the first electrode layer and the second electrode layer disposed under the first electrode layer.

9. The touch screen panel as claimed in claim 1, wherein the multilayered structure includes the first electrode layer and the second electrode layer disposed on the first electrode layer.

10. The touch screen panel as claimed in claim 1, wherein the multilayered structure includes two of the first electrode layers and the second electrode layer disposed between the two first electrode layers.

11. The touch screen panel as claimed in claim 1, wherein the multilayered structure includes two of the second electrode layers and the first electrode layer disposed between the two second electrode layers.

12. The touch screen panel as claimed in claim 1, wherein the multilayered structure includes at least two of the first electrode layers and at least two of the second electrode layers and wherein the first electrode layers and the second electrode layers are alternately layered.

13. The touch screen panel as claimed in claim 1, wherein all of the first sensing patterns and the second sensing patterns have the multilayered structure including the first and second electrode layers.

14. The touch screen panel as claimed in claim 13, wherein the first sensing patterns and the second sensing patterns have the same multilayered structure.

15. The touch screen panel as claimed in claim 1, wherein the first sensing patterns and the second sensing patterns are alternately arranged in the touch active region to form a capacitive sensing cell such that the first sensing patterns positioned along a same row or along a same column are connected to each other by way of first connecting patterns arranged at the row or at the column in the first direction and such that the second sensing patterns positioned at a same row or at a same column are connected to each other by way of second connecting patterns arranged along the row or along the column in the second direction crossing the first direction.

16. A touch screen panel comprising:
a plurality of spaced apart first sensing patterns that extend across the touch screen panel in a first direction and
a plurality of spaced apart second sensing patterns that extend across the touch screen panel in a second direction that crosses the first direction,
wherein the plurality of first sensing patterns and the plurality of second sensing patterns are spaced apart from each other in a third direction perpendicular to the first direction and the second direction to form a resistive touch electrode, and
wherein at least one of the first sensing patterns and the second sensing patterns has an multilayered structure including at least one first electrode layer made of transparent conductive material and at least one second electrode layer made of non-transparent conductive material.

17. The touch screen panel as claimed in claim 1, wherein at least one of the first sensing patterns and the second sensing patterns is formed on an upper substrate of a display panel positioned under the touch screen panel such that the at least one of the first sensing patterns and the second sensing patterns is integrated with the display panel.

18. A display device comprising:
a display panel that displays an image; and
a touch screen panel disposed on the display panel and including a plurality of first sensing patterns and a plurality of second sensing patterns;
wherein at least some of the first sensing patterns and the second sensing patterns are formed on the upper substrate of the display panel so that the display panel is integrated with the touch screen panel, and
at least one of the first sensing patterns and the second sensing patterns has an multilayered structure including at least one first electrode layer made of transparent conductive material and at least one second electrode layer made of non-transparent conductive material.

19. The display device as claimed in claim 17, wherein a thickness of the second electrode layer is less than that of the first electrode layer.

20. The display device as claimed in claim 17, wherein the second electrode layer is made of a material selected from the group of silver (Ag), gold (Au), magnesium (Mg), copper (Cu), aluminum (Al), nickel (Ni), and alloys thereof.

21. The display device as claimed in claim 17, the second electrode layer is made of silver (Ag) and wherein the thickness of the second electrode layer in a range from 10 Å to 500 Å.

22. The display device as claimed in claim 17, the second electrode layer is made of silver (Ag) and wherein the thickness of the second electrode layer in a range from 10 Å to 120 Å.

23. The display device as claimed in claim 17, the second electrode layer is made of silver (Ag) and wherein the thickness of the second electrode layer in a range from 200 Å to 500 Å.

24. A touch screen panel comprising a plurality of sensing patterns that have a multilayered structure including at least one first electrode layer made of indium titanium oxide (ITO) or indium zinc oxide (IZO) and at least one second electrode layer made of silver (Ag), gold (Au), magnesium (Mg), copper (Cu), aluminum (Al), nickel (Ni), or alloys thereof, wherein a thickness of the second electrode layer is less than that of the first electrode layer.
